(19) United States
(12) Patent Application Publication
(10) Pub. No.: US 2026/0086809 A1
(43) Pub. Date: Mar. 26, 2026

(54) Single Use Result for Data Processing

(71) Applicant: Apple Inc., Cupertino, CA (US)

(72) Inventors: Peter C. Eastty, San Francisco, CA (US); Aniruddha Satoskar, Round Rock, TX (US); Brendan C. Larks, San Diego, CA (US); Richard T. Witek, Bellevue, WA (US)

(21) Appl. No.: 19/002,443

(22) Filed: Dec. 26, 2024

Related U.S. Application Data
(60) Provisional application No. 63/699,712, filed on Sep. 26, 2024.

(51) Int. Cl. G06F 9/30; G06F 9/38

(52) U.S. Cl. CPC G06F 9/30181; G06F 9/3802

(57) ABSTRACT

An electronic device is provided that includes instruction fetch circuitry that fetches an instruction including a single-use result field, compute circuitry that operates on data based on the instruction to generate a result, and write-back circuitry that selectively writes the result to memory based on the single-use result field of the instruction.

### CROSS-REFERENCE TO RELATED APPLICATIONS

This application claims priority to U.S. Provisional Application No. 63/699,712, filed Sep. 26, 2024, which is incorporated by reference herein in its entirety.

### BACKGROUND

The present disclosure relates generally to data processing. More particularly, the present disclosure relates to selectively writing results of a data processing operation to memory.

A variety of data-processing operations, such as audio processing, involve performing operations on data stored in memory. After performing an operation on the data, the resulting processed data may be written into memory for possible use in a future operation. Many processors may perform multi-threaded operation, meaning that a first thread performing one type of processing operation may be preempted by a second thread. In such cases, the first thread may read processed data from memory to continue processing the data after the second thread completes processing. Thus, writes to memory may be useful for multi-threaded processing. However, writes to memory performed by the system may consume resources (e.g., power, memory controller circuitry resources) and/or increase latency.

### SUMMARY

Since writes to memory performed by a data processing system may consume resources and/or increase latency, it may be desirable to avoid writing data to memory in certain cases. For example, when the results of an instruction executed by a data processing pipeline are to be used within a threshold number of instructions and not used after, it may be faster and less resource-intensive to use the result for the subsequent instruction without writing the result to memory. Embodiments disclosed herein are directed towards a data processing system that uses a single-use result field of an instruction based on a data address of the instruction and write addresses of other instructions to determine whether to perform a write of the result to memory. The data processing system may thus selectively write a result of an instruction to memory based on the single-use result field of the instruction being set. Based on the single-use result field, the data processing system may not write the result to memory if the result is to be used within a threshold number of instructions and not used after. Even if the single-use result field is set (indicating that the result is not to be used beyond some threshold number of instructions), the data processing system may still choose to write the result to memory if an execution thread of the instruction is preempted during execution of the instruction.

### BRIEF DESCRIPTION OF THE DRAWINGS

Various aspects of this disclosure may be better understood upon reading the following detailed description and upon reference to the drawings in which:

FIG. 1 is a block diagram of an electronic device, according to embodiments of the present disclosure;

FIG. 2 is a front view of a handheld device representing an example of the electronic device of FIG. 1, according to embodiments of the present disclosure;

FIG. 3 is a front view of another handheld device representing another example of the electronic device of FIG. 1, according to embodiments of the present disclosure;

FIG. 4 is a perspective view of a notebook computer representing an example of the electronic device of FIG. 1, according to embodiments of the present disclosure;

FIG. 5 illustrates front and side views of a wearable electronic device representing another example of the electronic device of FIG. 1, according to embodiments of the present disclosure;

FIG. 6 is a perspective view of an audio device representing an example of the electronic device of FIG. 1, according to embodiments of the present disclosure;

FIG. 7 is a perspective view of a headset representing an example of the electronic device of FIG. 1, according to embodiments of the present disclosure;

FIG. 8 is a block diagram of a data processing system of the electronic device of FIG. 1 including a compiler and data processing circuitry, according to embodiments of the present disclosure;

FIG. 9 is an illustration of an example of an instruction that may be executed by the data processing system of FIG. 8, according to embodiments of the present disclosure;

FIG. 10 illustrates a set of instructions that may be analyzed by the compiler of FIG. 8 to determine whether to set a single-use result field for each of the instructions, according to embodiments of the present disclosure;

FIG. 11 is a flow chart of a method for selectively setting a single-use result field of an instruction that may be performed by the compiler of FIG. 8, according to embodiments of the present disclosure;

FIG. 12 illustrates the set of instructions of FIG. 10 that is preempted by instructions of a different thread during execution by the data processing circuitry of FIG. 8, according to embodiments of the present disclosure;

FIG. 13 is a flow chart of a method that may be performed by the data processing circuitry of FIG. 8 to selectively write a result of an instruction to memory based on a single-use result field, according to embodiments of the present disclosure;

FIG. 14 is a block diagram the data processing circuitry of FIG. 8, according to embodiments of the present disclosure; and

FIG. 15 is a schematic diagram of logic circuitry that may be used to selectively write a result to memory based on the single-use result field, according to embodiments of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “one embodiment,” “an embodiment,” “embodiments,” and “some embodiments” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

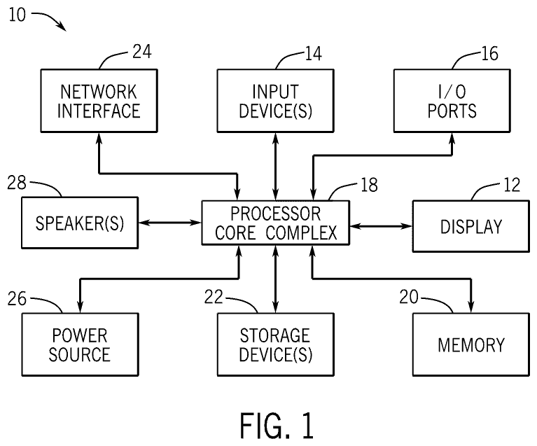

FIG. 1 is a block diagram of an electronic device 10 including an electronic display 12, according to embodiments of the present disclosure. As is described in more detail below, the electronic device 10 may be any suitable electronic device, such as a computer, a mobile phone, a portable media device, a tablet, a television, a virtual-reality headset, a wearable device such as a watch, a vehicle dashboard, earphones, a headset, or the like. Thus, it should be noted that FIG. 1 is merely one example of a particular implementation and is intended to illustrate the types of components that may be present in an electronic device 10.

The electronic device 10 includes the electronic display 12, one or more input devices 14, one or more input/output (I/O) ports 16, a processor core complex 18 having one or more processing circuitry(s) or processing circuitry cores, local memory 20, a main memory storage device 22, a network interface 24, a power source 26 (e.g., power supply), and one or more speakers 28. The various components described in FIG. 1 may include hardware elements (e.g., circuitry), software elements (e.g., a tangible, non-transitory computer-readable medium storing executable instructions), or a combination of both hardware and software elements. It should be noted that the various depicted components may be combined into fewer components or separated into additional components. For example, the local memory 20 and the main memory storage device 22 may be included in a single component. Further, it should be noted that the electronic device 10 may include dithering circuitry to perform embodiments described herein.

The processor core complex 18 is operably coupled with local memory 20 and the main memory storage device 22. Thus, the processor core complex 18 may execute instructions stored in local memory 20 and/or the main memory storage device 22 to perform operations, such as generating or transmitting image data to display on the electronic display 12. As such, the processor core complex 18 may include one or more processors, one or more general purpose microprocessors, one or more application specific integrated circuits (ASICs), one or more field programmable gate arrays (FPGAs), or any combination thereof. In some embodiments, a system on a chip (SoC) may include the processor core complex 18, among other things.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network; a local area network (LAN), such as an 802.11x Wi-Fi network; or a wide area network (WAN), such as a 4G, Long-Term Evolution (LTE), or 5G cellular network.

The power source 26 may provide electrical power to one or more components in the electronic device 10, such as the processor core complex 18 or the electronic display 12. For example, the power source 26 may include a power supply rail and/or a ground terminal coupled to the one or more components in the electronic device 10, such as the processor core complex 18 or the electronic display 12, to provide the electrical power. Thus, the power source 26 may include any suitable source of energy, such as a rechargeable lithium polymer (Li-poly) battery or an alternating current (AC) power converter.

The I/O ports 16 may enable the electronic device 10 to interface with other electronic devices. For example, when a portable storage device is connected, the I/O port 16 may enable the processor core complex 18 to communicate data with the portable storage device. The input devices 14 may enable user interaction with the electronic device 10, for example, by receiving user inputs via a button, a keyboard, a mouse, a trackpad, or the like. The input device 14 may include touch-sensing components in the electronic display 12. The touch sensing components may receive user inputs by detecting occurrence or position of an object touching the surface of the electronic display 12. The speakers 28 may enable the electronic device 10 to convert electrical signals into audible sound. That is, the electronic device 10 may generate one or more audio signals, add a dither signal to the audio signals, and output the dithered audio signal via the speakers 28. Thus, the speakers 28 may include components for amplifying and projecting sound to provide the dithered audio output for various applications.

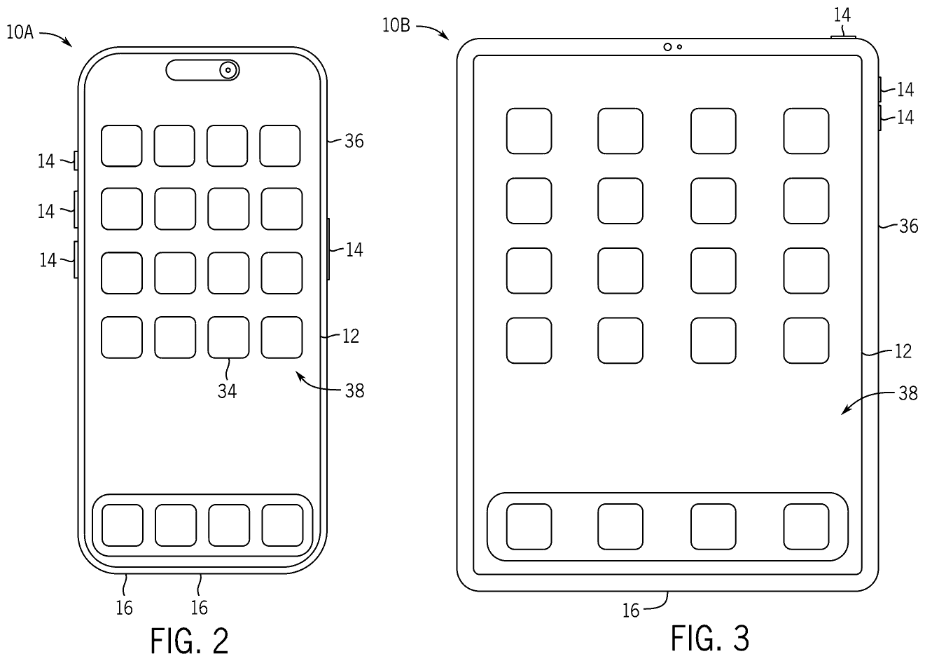

An example of the electronic device 10, a handheld device 10A, is shown in FIG. 2. The handheld device 10A may be a portable phone, a media player, a personal data organizer, a handheld game platform, or the like. For illustrative purposes, the handheld device 10A may be a smart phone, such as an IPHONE® model available from Apple Inc. The handheld device 10A includes an enclosure 36 (e.g., housing). The enclosure 36 may protect interior components from physical damage or shield them from electromagnetic interference, such as by surrounding the electronic display 12. The electronic display 12 may display a graphical user interface (GUI) 38 having an array of icons. As such, when an icon 34 is selected either by an input device 14 or a touch-sensing component of the electronic display 12, an application program may launch.

The input devices 14 may be accessed through openings in the enclosure 36. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, or toggle between vibrate and ring modes.

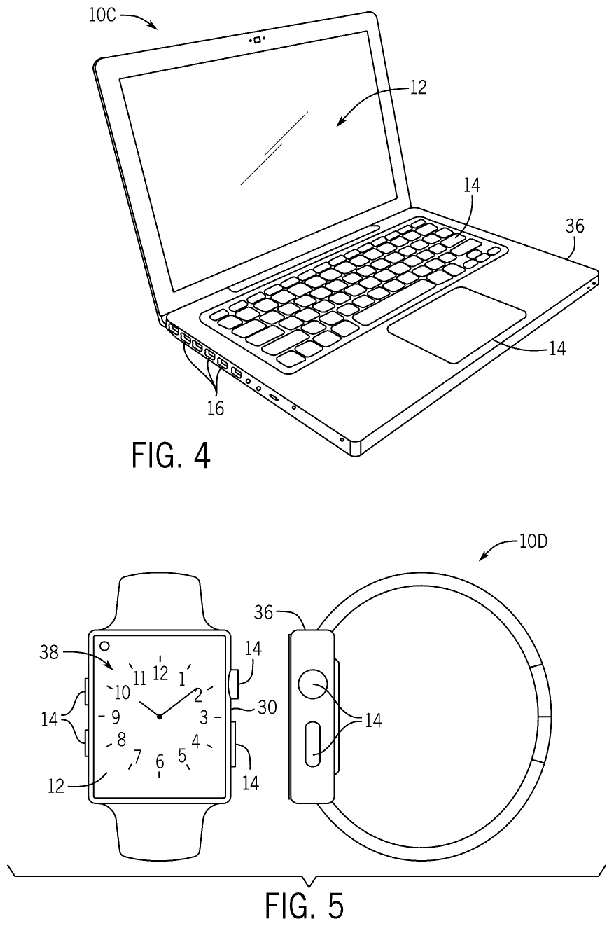

Another example of a suitable electronic device 10, specifically a tablet device 10B, is shown in FIG. 3. The tablet device 10B may be an IPAD® model available from Apple Inc. A further example of a suitable electronic device 10, specifically a computer 10C, is shown in FIG. 4. For illustrative purposes, the computer 10C may be a MACBOOK® or IMAC® model available from Apple Inc. Another example of a suitable electronic device 10, specifically a watch 10D, is shown in FIG. 5. For illustrative purposes, the watch 10D may be an APPLE WATCH® model available from Apple Inc.

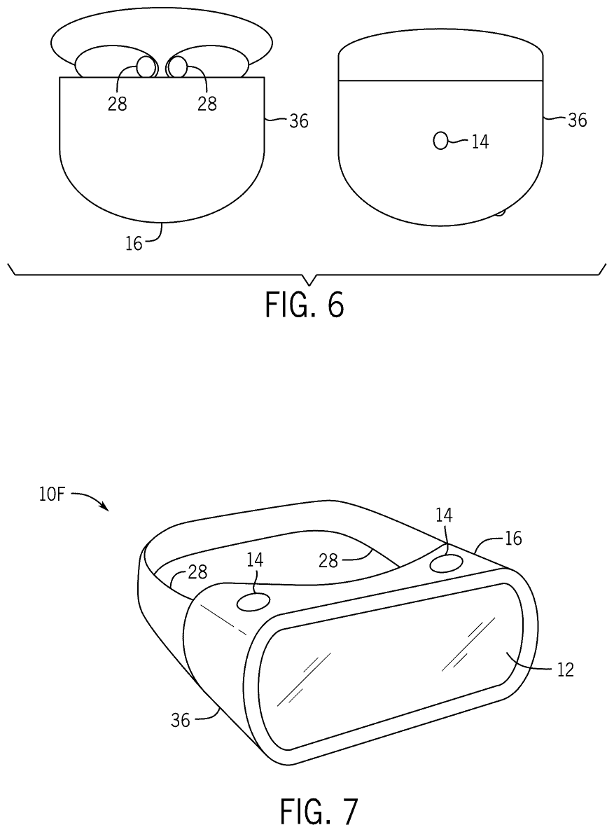

Another example of a suitable electronic device 10, specifically an audio device 10E, is shown in FIG. 6. For illustrative purposes, the audio device 10E may be an AIRPODS® model available from Apple Inc. Another example of a suitable electronic device 10, specifically a headset 10F (e.g., an extended reality (XR), mixed reality (MR), virtual reality (VR), and/or augmented reality (AR) headset), is shown in FIG. 7. For illustrative purposes, the headset 10F may be a VISION PRO® model available from Apple Inc.

As depicted, the tablet device 10B, the computer 10C, the watch 10D, and the headset 10F each also includes an electronic display 12, input devices 14, I/O ports 16, the speakers 28, and an enclosure 36. The electronic display 12 may display a graphical user interface (GUI) 38. As shown in FIG. 5, the GUI 38 may show a visualization of a clock. When the visualization is selected either by the input device 14 or a touch-sensing component of the electronic display 12, an application program may launch, such as to transition the GUI 38 to presenting the icons 34 discussed with respect to FIGS. 2 and 3. Further as depicted, the audio device 10E may include the input devices 14, the I/O ports 16, the speakers 28, and the enclosure 36.

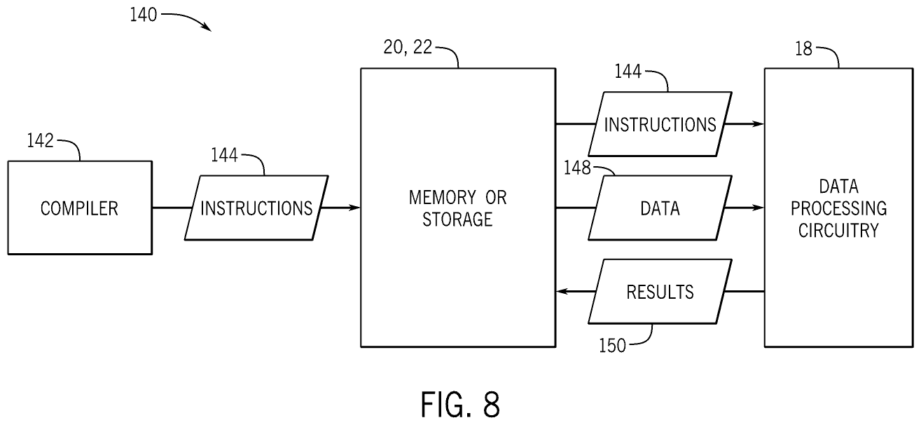

During runtime, the electronic device 10 may execute instructions to perform various functions. Since writes to memory performed by the electronic device 10 may consume resources and/or increase latency, it may be desirable to avoid writing data to memory when the results of an executed instruction are to be used within a threshold number of instructions and not used after. As shown in FIG. 8, a software development system 140 may include a compiler 142 to generate instructions 144 that include a single-use result field of an instruction based on a data address of the instruction and write addresses of other instructions. The compiler 142 may itself represent a software module corresponding to instructions stored on a tangible, non-transitory, computer-readable medium and may run on any suitable data processing system (e.g., data processing circuitry 100 of the processor core complex 18 on an electronic device 10 or other computer used by a developer to develop the instructions 144). The instructions 144 that are generated by the compiler 142 may be executed during runtime by the electronic device 10. For example, as illustrated in FIG. 8, the instructions 144 may be stored in the memory 20 or storage 22 and executed by data processing circuitry 100 of the processor core complex 18.

The data processing circuitry 100 of the processor core complex 18 may receive the instructions 144 and data 148 from the memory 20 or storage 22. The data processing circuitry 100 of the processor core complex 18 may operate on the data 148 (e.g., multiply, add, subtract, etc.) based on the instructions 144. Results 150 of executing an instruction 144 may be subsequently used by the data processing circuitry 100 of the processor core complex 18 in a future instruction 144 and/or may be selectively written back into the memory 20 or storage 22. During runtime, the data processing circuitry 100 of the processor core complex 18 may selectively write results 150 of the instructions 144 to the memory 20 or storage 22 based on a state of a single-use result field of each instruction 144.

During compilation, to set the single-use result fields of the instructions 144, the compiler 142 may set or not set the single-use result field of each instruction 144 based on whether the result 150 from executing that instruction 144 is to be used within a threshold number of instructions 144 and then not used after. This is something that the compiler 142 may be able to identify during compilation that would not be readily apparent to the data processing circuitry 100 of the processor core complex 18 during runtime. This is because the compiler 142 may be able to review all of a particular collection of instructions 144, but the data processing circuitry 100 of the processor core complex 18 during runtime may execute the instructions 144 sequentially and thus only have visibility into a subset of them. In this way, the single-use result field of the instructions 144 may provide a hint to the data processing circuitry 100 of the processor core complex 18 to allow the data processing circuitry 100 of the processor core complex 18 to determine whether or not to write the results 150 back to the memory 20 or storage 22. Note that, even if the single-use result field is set in an instruction 144 (indicating that the result 150 is not to be used beyond some threshold number of instructions 144), the data processing circuitry 100 of the processor core complex 18 may still choose to write the result 150 to the memory 20 or storage 22 if an execution thread of the instructions 144 is preempted during execution of the instructions 144.

Indeed, the compiler 142 may selectively set the single-use result field of each instruction 144 based on any suitable analysis that may assist the data processing circuitry 100 in efficiently executing the instructions 144 by providing a hint with respect to writing the results 150 back to memory. For example, the compiler 142 may analyze a set of the instructions 144 to determine whether a result of a producer instruction is to be used as input by a consumer instruction within a threshold number of instructions from the producer instruction. The threshold number of instructions may correspond to a number of pipeline stages that the data processing circuitry of the processor core complex 18 uses to execute an instruction. If the compiler 142 determines that the result of a producer instruction is to be used within the threshold number of instructions and is not to be used by an instruction outside the threshold number of instructions, the compiler 142 may set a single-use result field of the producer instruction. The single-use result field of the instruction may be used by the data processing circuitry 100 to selectively write or not write a result of the instruction to the storage or memory 20, 22.

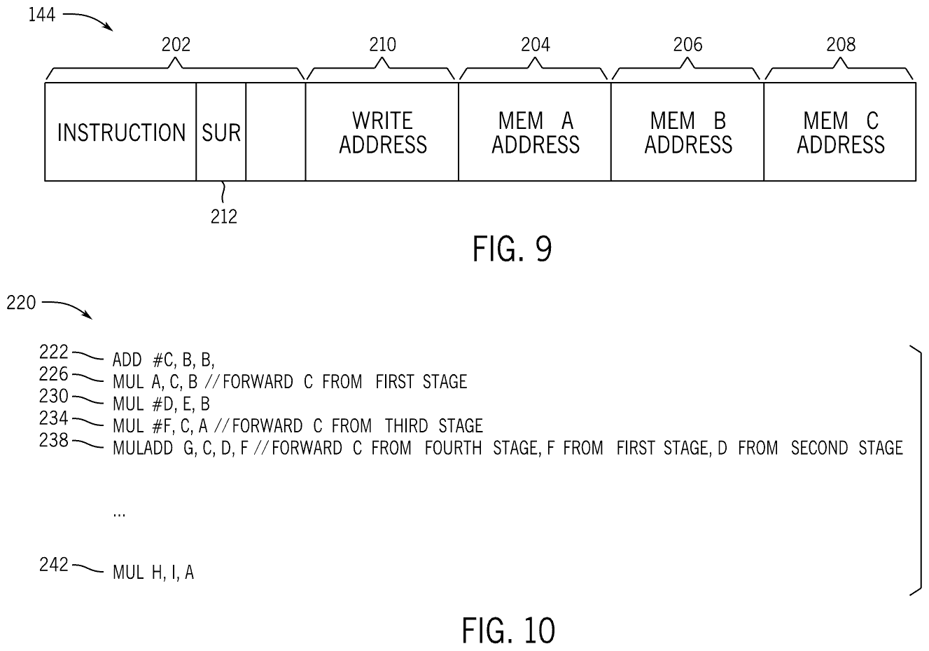

FIG. 9 is an illustration of an example of an instruction 144 that may be generated by the compiler 142 and executed by the data processing circuitry 100. As illustrated, the instruction 144 may include an instruction field 202, which may include multiple bits that indicate an instruction for the data processing circuitry 100 to execute, such as a multiply-add (mul-add), addition, subtraction, multiplication, division, trigonometric function, polynomial or the like. In the illustrated example, the instruction 144 includes a first data address field 204 that indicates the location (e.g., in the memory or storage 20, 22) of a first operand, a second data address field 206 that indicates the location of a second operand, and a third data address field 208 that indicates a location of a third operand. In other examples, the instruction 144 may include additional data address fields, such as four or more address fields. In addition, the instruction 144 includes a write address field 210 that indicates a location in the storage or memory 20, 22 at which results of the instruction are to be written to after execution.

The instruction 144 may also include a single-use result field 212, which may be set to specific values (e.g., binary states when a single bit) by the compiler to indicate whether results of the instruction 144 are to be used by one or more consumer instructions within a threshold number of instructions and not to be used thereafter. As illustrated, the single-use result field 212 may be embedded as part of the instruction field. In other examples, the single-use result field 212 may be included immediately before or after the other contents of the instruction field 202. Additionally or alternatively, the single-use result field 212 may be arranged elsewhere as part of the instruction 144, such as between, after, or embedded in the write address field 210 or the first, second, and third data address fields 204, 206, and 208.

Further, the single-use result field 212 may be of any size or number of bits. In one example, the single-use result field 212 include a single binary bit that is set high by the compiler if the results of the instruction 144 are to be used within a threshold number of instructions or set low by the compiler if the results of the instruction 144 are not to be used in subsequent instructions and/or will be used by an instruction beyond the threshold number of instructions. In another example, the single-use result field 212 may include multiple bits, and the value indicated by the multiple bits may indicate additional conditions. For example, various values indicated by the multiple bits may indicate a number of subsequent instructions that are to use the results of the instruction 144 (e.g., the compiler may have set multiple bits of the single-use result field based on the number of subsequent instructions). In another example, the multiple bits may indicate the threshold number of instructions (e.g., based on a number of pipeline stages of the data processing circuitry 100).

During compilation of a set of the instructions 144, the compiler may determine, based on the comparisons described above, whether the results of the instruction 144 are to be used within a threshold number of instructions following the instruction 144 and are not to be used after the threshold number of instructions. If the compiler determines that the results of the instruction 144 are not to be used by subsequent instructions and/or that the results are to be used by a subsequent instruction beyond the threshold number of instructions, the compiler may leave the single-use result field 212 unchanged. Additionally or alternatively, the compiler may set the single-use result field 212 to a value indicating that the results of the instruction 144 are not to be used in subsequent instructions. In response, the data processing circuitry 100 may, after execution of the instruction 144, store the results of the instruction 144 in a write address indicated by the write address field 210.

If, however, the compiler determines that the results of the instruction 144 are to be used within a threshold number of instructions following the instruction 144 and are not to be used by a subsequent instruction beyond the threshold number of instructions, the compiler may set the single-use result field 212 to a value indicating the determination. For example, the compiler may set the single-use result field 212 to a high value (e.g., “1”, “111”). As such, after completion of the instruction 144, the data processing system 100 may use the results of the instruction 144 in subsequent instructions without writing the results to the write address indicated by the write address field 210.

FIG. 10 illustrates a set of instructions 220 that may be analyzed by the compiler to determine whether to set a single-use result field for each of the instructions. In the illustrated example, a first instruction 222 includes an add instruction that adds two operands, each located in the memory or storage 20, 22 at a location b and generates a result to be stored at a location c. The compiler may analyze the set of instructions 220 and determine that a second instruction 226, a fourth instruction 234, and a fifth instruction 238 are within a threshold number of instructions from the first instruction 222 and read from the location c as an input. This may indicate that the second instruction 226, the fourth instruction 234, and the fifth instruction 238 use the result of the first instruction 222 as input, for instance. The compiler may also determine that no instruction beyond the threshold number of instructions reads from the location c. In response, the compiler 142 may set the single-use result field of the first instruction 222. This is illustrated in FIG. 10 by the use of “#c” in the instruction 222.

For the second instruction 226, the compiler 142 may determine that the location at which the results of the second instruction 226 are to be stored is not accessed by an instruction within the threshold number of instructions. As illustrated, a later instruction, such as a sixth instruction 242, may access the location to which the result of the second instruction is stored. However, since the sixth instruction 242 is beyond the threshold number of instructions from the second instruction 226, the compiler 142 may not set the single-use result field of the second instruction 226.

Further, the compiler 142 may determine that a location d at which the result of the third instruction 230 is to be accessed as input for the fifth instruction 238 and not beyond the threshold number of instructions from the third instruction and may set the single-use result field of the third instruction 230. This is illustrated in FIG. 10 by the use of “#d” in the instruction 230. Likewise, the compiler 142 may determine that a location f of the fourth instruction 234 is to be accessed as input for the fifth instruction 238 and not beyond the threshold number of instructions from the third instruction and may set the single-use result field of the fourth instruction 234. This is illustrated in FIG. 10 by the use of “#f” in the instruction 234. Additionally, the compiler 142 may determine that a location g at which a result of the fifth instruction 238 is not to be accessed for input to any later instruction in the set of instructions 220 and may thus not set the single-use result field of the fifth instruction.

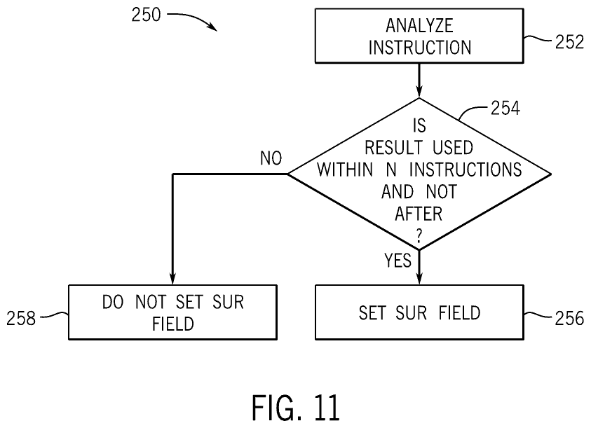

FIG. 11 is a flow chart of a method 250 carried out by the compiler for selectively setting a single-use result field of an instruction. In block 252, the compiler 142 may analyze a set of instructions by, for example, receiving the instructions, converting the instructions to a language readable by the data processing circuitry 100, and determining aspects of the instructions, such as addresses from which the instructions are to read as input, addresses at which results of the instructions are to be stored, and so on.

In block 254, the compiler 142 may determine, for each producer instruction that produces a result, whether the result of the producer instruction is to be used as input by a later instruction within a threshold number of instructions. The compiler 142 may also determine, for each producer instruction, whether the result of the producer instruction is not to be used by a later instruction beyond the threshold number of instructions. If the result of the producer instruction is to be used by a later instruction within the threshold number of instructions and is not to be used beyond the threshold number of instructions, the compiler may set the single-use result field for the producer instruction in block 256. If the compiler 142 determines that the result of the producer instruction is to be used beyond the threshold number of instructions from the producer instruction, in block 258, the compiler 142 may not set the single-use result field for the producer instruction.

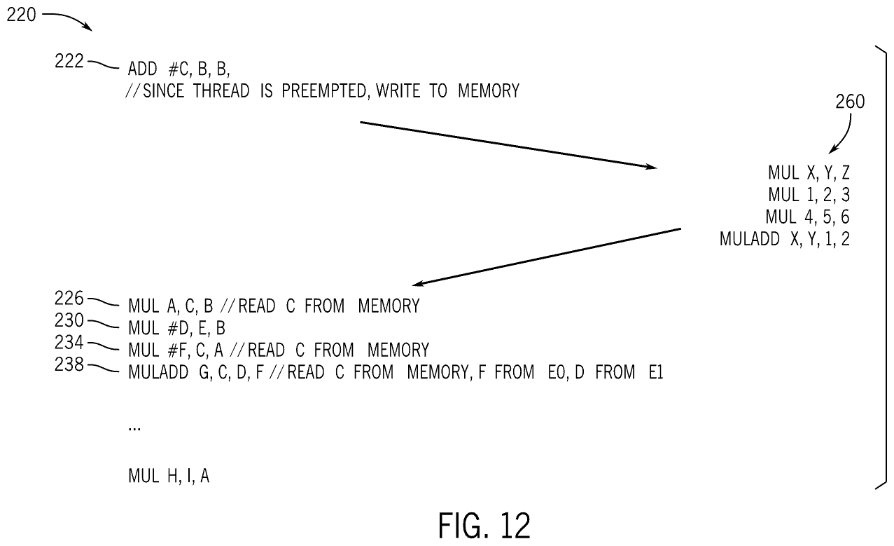

FIG. 12 illustrates the effect of thread preemption on the set of instructions 220 when the set of instructions 220 is preempted by instructions 260 of a different thread during execution by the data processing circuitry 100. As mentioned, the first instruction 222 may have a single-use result field that is set by the compiler 142 based on a determination that the result of the first instruction 222 is to be used by a later instruction of the set of instructions 220 (e.g., the second instruction 226). However, during execution of the set of instructions 222 on a first thread, the first thread may be preempted by the set of instructions 260 on a second thread of a higher priority than the first thread. Based on the first thread being preempted by the second thread, the data processing circuitry 100 may write the result of the first instruction 222 to the memory or storage 20, 22 (e.g., may ignore the setting of the single-use result field of the first instruction 222).

By writing the result of the first instruction 222 to the memory or storage 20, 22, the result may be accessed by later instructions. For example, when the data processing circuitry 100 has completed execution of the set of instructions 260 on the second thread and returns to executing the set of instructions 220 on the first thread, the data processing circuitry 100 may execute the second instruction 226. To do so, the data processing circuitry 100 may read the result of the first instruction 226 from the location c of the memory or storage 20, 22. The data processing circuitry 100 may move on to execution of the third instruction 230 and the fourth instruction 234. The data processing circuitry 100 may not write the results of the third instruction 230 and the fourth instruction 234 to the memory or storage 20, 22 because the single-use result field for the third instruction 230 and the fourth instruction 234 is set. As such, when the data processing circuitry 100 executes the fifth instruction 238, the data processing circuitry may read a first operand from the location c in memory (because the first thread was preempted after execution of the first instruction 222) and may forward the results of the third instruction 230 and the fourth instruction 234 to use as input without reading from the memory or storage 20, 22.

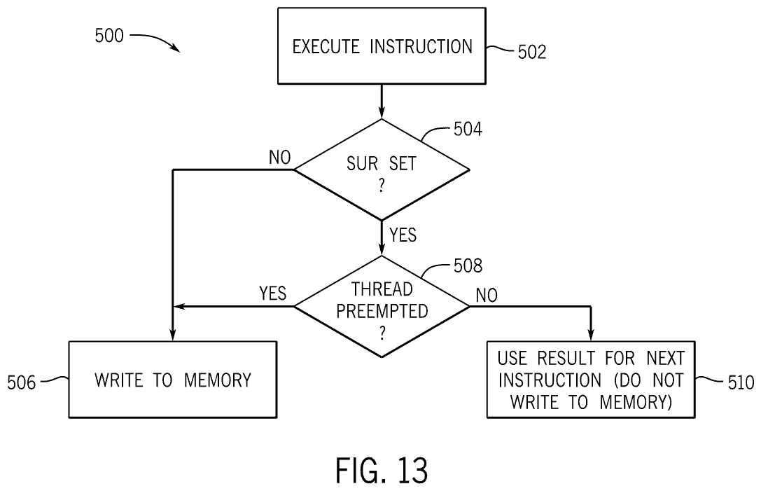

To illustrate further, FIG. 13 is a flow chart of a method 500 that may be performed by the data processing circuitry 100 to selectively write a result of an instruction to memory based on a single-use result field. In block 502, the data processing circuitry 100 may begin execution of an instruction. This may include addresses of the instruction, fetching operands of the instruction, and using computation components to execute the instruction and produce a result. In block 504, the data processing system may determine whether the single-use result field of an instruction is set to a particular value. The value may indicate, for example, that the result of the instruction is to be used by one or more subsequent instructions and is not to be used beyond a threshold number of instructions, which may correspond to a number of pipeline stages executed by the data processing circuitry 100. If the single-use result field is not set, in block 506, the data processing circuitry 100 may write the result of the instruction to memory. The data processing circuitry 100 may write the result to an address is memory indicated by a write address field of the instruction, for instance.

If, however, the single-use result field of the instruction is set, in block 508, the data processing circuitry 100 may determine whether a thread of the instruction is preempted by a different thread. This may include, for instance, comparing a thread number of the instruction with thread numbers of other instructions in a processing pipeline of the data processing circuitry 100. If the thread of the instruction has been preempted, the data processing circuitry 100 may write the result of the instruction to memory in block 506. If, however, the thread is not preempted, in block 510, the data processing circuitry 100 may use the result of the instruction for a subsequent instruction without writing the result to memory. The data processing circuitry 100 may temporarily hold the result in a local register, for instance, such that it can be accessed for the subsequent instruction.

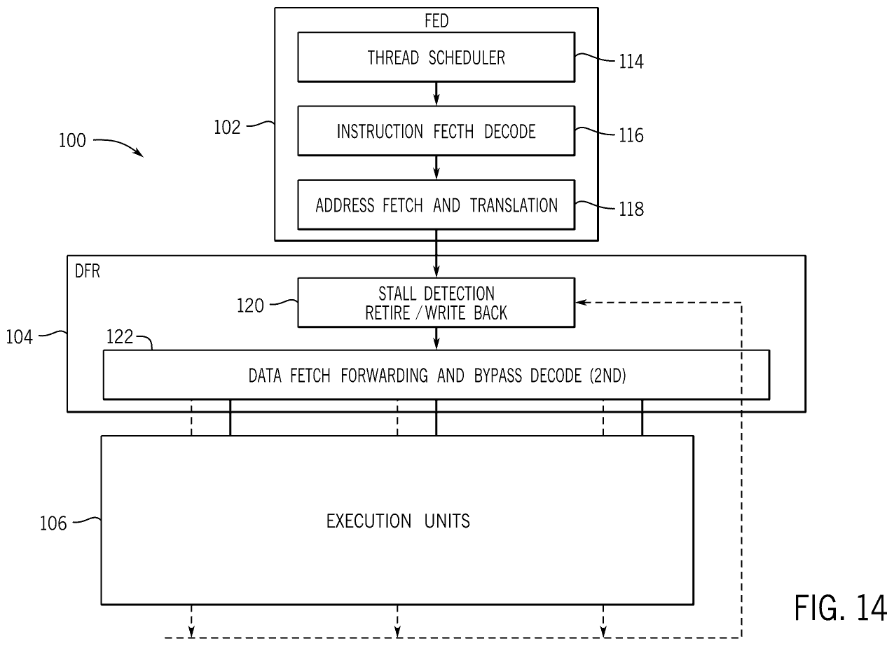

FIG. 14 is a block diagram of one example of the data processing circuitry 100. The data processing circuitry 100 may include and/or be included as part of hardware elements, software elements, or a combination of both hardware and software elements, such as a compiler, the processor core complex 18, the memory 20, and/or the storage device(s) 22 of FIG. 1. The data processing circuitry 100 may perform data processing operations using multiple execution threads, and each of the multiple threads may perform various data processing operations, as described herein. In one example, a programming model defines a set of conditions for each of the multiple threads that may include, for instance, input and output channels for each of the multiple threads. When certain conditions are met, such as every input channel holding valid data and every output channel being vacant, a thread may be enabled to run. Once a thread is enabled to run, the enabled thread may consume input (e.g., samples of data) from the input channels, produce a result at the output channels, and halt until the next round of execution.

As illustrated, the data processing circuitry 100 includes a fetch-decode (FED) component 102 that selects a thread for the data processing circuitry 100 to execute. The data processing circuitry 100 also includes a data-fetch-retirement (DFR) component 104 that interfaces with one or more computation components 106 to determine a result (e.g., output) based on one or more inputs (e.g., operands) provided by the DFR component 104. The data processing circuitry 100 may include more or fewer computation components 106 than are shown here. The DFR component 104 may include write-back circuitry 122 that selectively writes results received from the one or more computation components 106 based on the single-use result field of the instruction.

The FED component 102 may include thread scheduler circuitry 114, instruction fetch circuitry 116, and address fetch circuitry 118. The thread scheduler circuitry 114 may initiate a finite-state machine (FSM) for each of the multiple threads of the data processing circuitry 100 and may update the FSM thereafter. For example, an FSM of a thread managed by the thread scheduler circuitry 114 may include states such as a reset state (e.g., start state) and a wait state, in which a thread waits to run until a missing condition is satisfied or a higher priority thread has completed execution, for instance. The states may also include a run state in which a thread runs. In some examples, the run state may only be entered for one thread at a time. Additionally, a thread may enter a pause state when the thread is preempted by a thread of a higher priority, or the thread may enter a halt state prior to reentering the wait, run, or reset states.

At the instruction fetch circuitry 116, the FED component 102 may read an instruction from an instruction memory and may decode the instruction. The instruction may be one of a set of instructions that has been compiled by a compiler. In some cases, an operand address of an instruction may match or correspond to a destination address of another instruction. As may be appreciated, this may be the case when an instruction uses the results of a prior instruction. For example, a thread may execute a multiply-accumulate (mul-add) operation to produce a result and may use the result in a successive operation, such as another mul-add operation. As such, during the compilation of the instructions, a compiler (e.g., compiler system, assembler, linker, or binder) may compare operand addresses and destination addresses of received instructions to determine a producer of operands of an instruction (e.g., a current instruction). If one or more of the operand addresses of a current instruction correspond to the destination operands of a prior instruction, the compiler may set a single-use result field of the prior instruction and/or the current instruction. Additionally, the FED component 102 may, at the address fetch circuitry 118, fetch operand addresses of one or more operands of the instruction and destination addresses of one or more destinations of the instruction. In some cases, the FED component 102 may translate the addresses if, for example, the addresses are located in different data memories.

The DFR component 104 may receive translated instructions and addresses from the FED component 102 for multiple instructions and may manage multiple instructions at various stages throughout an execution pipeline. The DFR component 104 may include stall detection and write back circuitry 120, also referred to herein as write back circuitry 120, that selectively writes a result of an instruction to memory. For example, the write back circuitry 120 may selectively write a result of an instruction to memory based on the single-use result field of the instruction. In some examples, the write back circuitry 120 may include stall detection circuitry that may, based on the detection of a stall, cause the write back circuitry 120 to write the result to memory regardless of the single-use result field. The DFR component 104 (e.g., data fetch circuitry 122) may execute an instruction in a first execution stage, in which an instruction is dispatched to one of the computation components 106, and a second execution stage, in which the DFR component 104 waits for the execution component to complete the instruction. As such, the DFR component 104 may simultaneously manage multiple instructions, each of which having a destination address and one or more operand addresses.

The DFR component 104 may dispatch an instruction, along with operands of the instruction, to one of the computation components 106 based on a type of the instruction. For example, the DFR component 104 may send instructions with arithmetic operations such as adds, subtractions, mul-adds, and the like, to an integer execution component of the computation components 106 and may send instructions with floating-point arithmetic operations to a floating-point execution component of the computation components 106. Further, the DFR component 104 may send instructions including one or more of a set of predefined functions (e.g., cosine, sine, reciprocals, exponential functions, logarithmic functions) to a transcendentals component of the computation components 106.

The results generated at the computation components 106 may also be forwarded to the write back circuitry 120. Based on contents of the single-use result field of the instruction executed to produce the results, the write back circuitry 120 may selectively write the results to memory. For example, if the single-use result field is set, the data processing system 100 may use the result of the prior instruction as an operand for the current instruction without writing the result of the prior instruction to memory or reading the operands of the current instruction from memory. Additionally, the write back circuitry 120 may perform an additional check to determine whether a result will be forwarded for use in a later instruction. Further, if a thread of the instruction executed to generate the result is preempted by a second thread, the write back circuitry 120 may write the result to memory (e.g., even if the single-use result field of the instruction is set). As such, resource usage associated with memory access by the data processing circuitry 100 may be reduced.

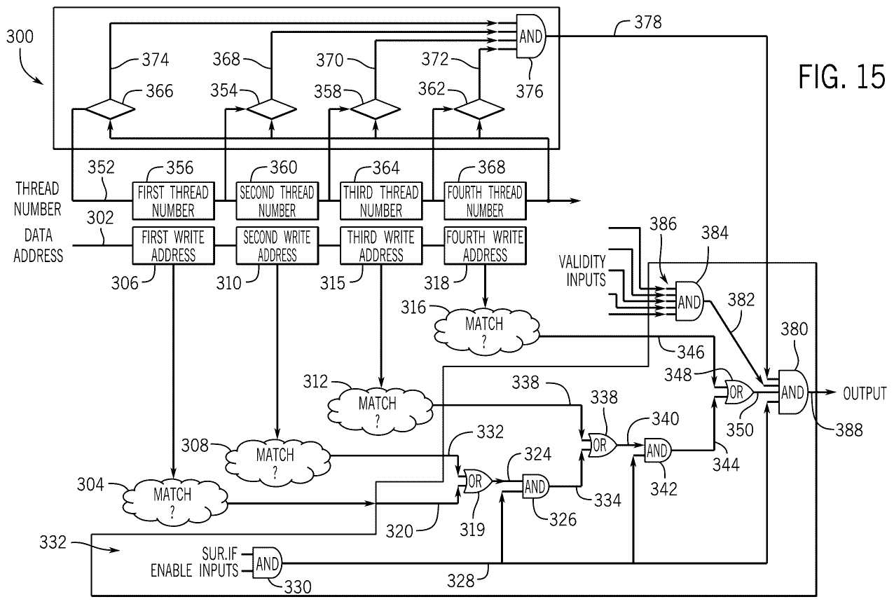

FIG. 15 is a schematic diagram of logic circuitry 300 that may be used to selectively write a result to memory based on the single-use result field. The logic circuitry 300 may be included as part of data fetch circuitry 120 or the write back circuitry 122 of the data processing circuitry 100, for instance. In the illustrated example, the logic circuitry 300 may determine whether one or more data address fields of a fetched instruction correspond to a write address field of other instructions various stages of an instruction pipeline of the data processing system 100. This determination may act as an additional check to ensure that data forwarding is to occur (e.g., in addition to the single-use result field) and has not been interrupted by, for example, preemption of one thread by another. Based on whether the results of an instruction are to be used in subsequent instructions, whether a single-use result field 333 is set, and/or whether a thread of an instruction is preempted by another thread, the data processing system 100 may selectively write the results to memory.

The logic circuitry 300 may compare, at a decision block 304, the data address 302 (e.g., of one or more operands) to a first write address 306 of an instruction that is in a data fetch stage of a pipeline. The logic circuitry 300 may also compare the data address 302, at a decision block 308, to a second write address 310 of a second instruction at a first execution stage. Additionally, the logic circuitry 300 may, at a decision block 312, compare the data address 302 a third write address 314 of a third instruction at a second execution stage. Further, the logic circuitry 300 may, at a decision block 316, compare the data address 302 to a fourth write address 318 of a fourth instruction at a write-back stage.

The logic circuitry 300 may include an OR gate 319 at an output 320 of the decision block 304 and an output 322 of the decision block 308. An output 324 of the OR gate 319 may indicate whether the data address 302 matches the first write address 306 or the second write address 310 and may be provided as input to an AND gate 326. Additionally, an enable output 328 of an AND gate 330 of one or more enable inputs 332 (e.g., control bits, configuration bits, chicken bits) and the single-use result field 333 may be provided as input to the AND gate 326. The single-use enable output 328 may indicate whether the single-use result field 333 of an instruction has been set by the compiler and whether selective writes based on the single-use result field 333 are enabled (e.g., as indicated by the one or more enable bits 332). For example, if the single-use enable output 328 is high, the data processing system 100 may not write results of an instruction to memory. An output 334 of the AND gate 326 and an output 336 of the decision block 312 may be provided as input to an OR gate 338. Further, an output 340 of the OR gate 338 and the single-use enable output 328 may be provided as input to an AND gate 342. An output 346 of the decision block 316 and an output 344 of the AND gate 342 may be provided as input to an OR gate 348, and an output 350 of the OR gate 348 may indicate whether the data address 302 corresponds to the first write address 306, the second write address 310, the third write address 314, and/or the fourth write address 318. Further, the output 350 may indicate whether a single-use result function of the data processing system 100 is enabled based on the one or more enable inputs 332 and whether data forwarding between instructions is to be performed (e.g., has not been interrupted by another process).

The logic circuitry 300 may also determine whether a thread number 352 of a fetched instruction corresponds to thread numbers of other instructions at various stages of execution by the data processing system 100. Any discrepancy between a thread number 352 of an incoming instruction and thread numbers of other instructions may cause the data processing circuitry 100 to write a result of the incoming instruction or other instructions to memory instead of using the result for subsequent instructions. To illustrate, the logic circuitry 300 may compare the thread number 352, at a decision block 354, to a thread number 356 of a first instruction at the data fetch stage. At a decision block 358, the logic circuitry 300 may compare the thread number 352 to a thread number 360 of a second instruction at a first execution stage. The logic circuitry 300, at a decision block 362, may compare the thread number 352 to a thread number 364 of a third instruction at a second execution stage. At a decision block 366, the logic circuitry 300 may compare the thread number 352 to a thread number 368 of a fourth instruction in a write-back stage.

An output 368 of the decision block 354, an output 370 of the decision block 358, an output 372 of the decision block 362, and an output 374 of the decision block 366 may be provided as input to an AND gate 376. An output 378 of the AND gate 376 may indicate whether threads of instructions being executed by the data processing system 100 are to be preempted by a thread of a fetched instruction. Additionally or alternatively, the output 378 may indicate whether the thread of the fetched instruction is to be preempted by thread of other instructions. In an example, the output 378 is a low value when the fetched instruction is associated with the same thread as the other instructions being executed.

The output 378 indicating thread preemption, the output 350 indicating matches between the data address and the write addresses, and the single-use enable output 328 may be provided as input to an AND gate 380. In addition, an output 382 of an AND gate 384 having one or more validity inputs 386 may be provided to the AND gate 380. The one or more validity inputs 386 may indicate, for example, that instructions at various stages of execution by the data processing system 100 have valid input channels and output channels, and the output 382 may indicate a validity of the instructions.

The logic circuitry 300 may produce an output 388 that indicates whether to write a result of an instruction to memory. The output 388 may be determined by the logic circuitry 300 based on whether the result of an instruction is to be used in subsequent instructions and/or is not to be used after the subsequent instructions. The output 388 may also be determined based on the single-use result field 333 and the one or more enable inputs 332. Additionally, the output 388 may be determined based on whether a thread will be preempted by another thread following execution of the instruction. The output 388 may also indicate whether the result of the instruction is not used by any other thread. In some cases, the output 388 may indicate whether an instruction is not followed by a subsequent halt instruction or a pipeline stall instruction and whether the instruction is writing to a rotating memory region. However, in some cases, one or more of the above factors may be omitted from the output 388. For example, the output 388 may be determined based on the single-use result field 333 and the one or more enable inputs 332 and not based on whether a thread will be preempted by another thread following execution of the instruction.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. An electronic device comprising:
instruction fetch circuitry configured to fetch an instruction comprising a single-use result field;
compute circuitry configured to operate on data based on the instruction to generate a result; and
write-back circuitry configured to selectively write the result to memory based on the single-use result field of the instruction.

2. The electronic device of claim 1, comprising stall detection circuitry configured to cause the write-back circuitry to write the result to memory regardless of the single-use result field of the instruction based on an occurrence of a stall.

3. The electronic device of claim 1, wherein the instruction fetch circuitry is configured to fetch the instruction, wherein the instruction comprises an instruction field, the single-use result field, a write address field, and a plurality of data address fields.

4. The electronic device of claim 3, wherein the single-use result field is embedded within the instruction field.

5. The electronic device of claim 1, wherein the single-use result field comprises a single bit.

6. The electronic device of claim 1, wherein the write-back circuitry is configured to write the result to memory based on a first execution thread of the compute circuitry.

7. The electronic device of claim 6, wherein the write-back circuitry is configured to write the result to memory in response to the first execution thread and second execution thread of the write-back circuitry differing.

8. The electronic device of claim 1, wherein the instruction comprises a write address field with an address, and wherein the single-use result field of the instruction is set to a first value in response to a data address field of an additional instruction having the address.

9. The electronic device of claim 8, wherein the instruction fetch circuitry is configured to receive the additional instruction after receiving the instruction.

10. The electronic device of claim 8, wherein the write-back circuitry is configured to selectively write the result to memory at the address.

11. An article of manufacture comprising a tangible, non-transitory, machine-readable medium having stored thereon an instruction having a format comprising:
an instruction field configured to specify an operation to use to process data;
a single-use result field configured to specify whether to write a result of the operation to a write address in first memory;
a write address field configured to specify the write address; and
a plurality of data address fields.

12. The article of manufacture of claim 11, wherein the single-use result field is embedded in the instruction field.

13. The article of manufacture of claim 11, wherein the single-use result field comprises a single bit.

14. A method comprising:
reading an instruction into processing circuitry;
operating on data based on the instruction in the processing circuitry to generate a result; and
selectively writing the result into memory based on a value of a first field of the instruction.

15. The method of claim 14, wherein the first field of the instruction comprises a single bit.

16. The method of claim 14, comprising:
selectively writing the result into memory based on one or more threads being executed by the processing circuitry.

17. The method of claim 16, comprising:
writing the result into memory based on the one or more threads differing, the one or more threads differing indicating preemption of execution of a first thread of the one or more threads by execution of a second thread of the one or more threads.

18. The method of claim 14, wherein selectively writing the result into memory based on the value of the first field of the instruction comprises:
writing the result into memory in response to the value indicating a first condition; and
including the result in an immediately subsequent instruction in response to the value indicating a second condition.

19. The method of claim 14, wherein the instruction comprises an address field with a write address,
and comprising:
reading additional address fields of one or more subsequent instructions; and
setting the first field of the instruction to a first value based on the additional address fields having the write address.

20. The method of claim 19, wherein the additional address fields of the one or more subsequent instructions correspond to read addresses of the one or more subsequent instructions, and wherein the additional address fields having the write address indicates that one or more subsequent instructions use the result.
